(19) United States
(12) Patent Application Publication
(10) Pub. No.: US 2023/0049943 A1
(43) Pub. Date: Feb. 16, 2023

(54) CONNECTORS AND METHODS UTILIZING WRAPPING AROUND A CENTRAL ELEMENT

(71) Applicant: MELNI, LLC, Twin Falls, ID (US)

(72) Inventors: MARK L. MELNI, TWIN FALLS, ID (US); CAMERON TROY WILLIAMS, TWIN FALLS, ID (US); MIKE J. WILMINK, LOS ANGELES, CA (US)

(21) Appl. No.: 17/873,071

(22) Filed: Jul. 25, 2022

Related U.S. Application Data
(60) Provisional application No. 63/225,363, filed on Jul. 23, 2021.

(51) Int. Cl. H01R 4/14; H01R 4/70

(52) U.S. Cl. CPC H01R 4/14; H01R 4/70

(57) ABSTRACT

A connector for elongated members such as wires or cables receives the members into holes in opposite ends of the connector, so that the members are offset radially outward from the central longitudinal axis of the connector on opposite sides of the axis. Portions of the connector housing may be twisted/rotated relative to each other on the axis to connect the members mechanically, and electrically if the members are conductive. The twisting/rotation of the housing portions moves the portions of the elongated members that are inside a hollow interior space of the connector to be against, and then to wrap around, a central, axial element that is on or near the central longitudinal axis of the connector. This causes each member to wrap around or adjacent to coils of the other member, forming a purposely tight and/or tangled knot of coils of both elongated members around the central element.

This application claims benefit of Provisional application entitled “Connectors and Methods Utilizing Wrapping Around a Central Element”, filed Jul. 23, 2021, and given Ser. No. 63/225,363, which is incorporated into this application in its entirety.

### FIELD OF THE INVENTION

The invention relates to a connector for various elongated members, wherein the members are wrapped around a central element by rotation of housing portion(s) that hold or guide the elongated members to accomplish the wrapping and knot-formation.

### SUMMARY

A connector, and associated methods, are adapted for insertion of multiple elongated members into the connector followed by twisting/wrapping the members around a central element to form a knot that mechanically connects the members. The twisting/wrapping is accomplished by rotating portions of the connector housing relative to each other, which wraps the members tightly around the central element and around each other to bind/tie the members together. The connector may be used for connecting various elongated members, such as electrical conductors, wires (solid, stranded, and/or cables), and, in certain embodiments, other elongated objects. In certain embodiments, the elongated members are electrically conductive, and the connector is used for quickly and reliably electrically connecting the conductors. Also, the central element may also be conductive, for enhancing the electrical connection between the elongated members.

In certain embodiments, the connector comprises two housing end portions (a “first housing end portion” and a “second housing end portion”, typically held together by a sleeve or other fastener) and a central element provided on the longitudinal central axis of the connector, wherein the central element extends from one of the housing end portions, through an interior space of the connector, and into the other housing end portion. In the “relaxed”, not yet actuated, configuration of the connector, the central element is preferably straight and parallel to the connector longitudinal central axis and its two opposing ends are slidably received in their respective opposing housing end portions, for example, in axial, elongated holes or recesses in the end portions. The central element is preferably rigid enough to remain in place on the central axis and in its holes/recesses at least prior to actuation of the connector by rotation of the housing portions and preferably prior to, during, and after actuation of the connector. However, in certain embodiments, the central element may be flexible enough that, upon actuation and the resultant large forces caused by the wrapping of the elongated members around it, the central element may bend and deform to some extent, as discussed later in this document.

In certain embodiments, the elongated members are elongated wires, lines, cables, ropes, straps, filaments, or strands (hereafter, called “wires” for simplicity, and preferably, but not necessarily in all embodiments, metal or electrically conductive material). A first elongated member extends axially through a bore in the first housing end portion, axially through an interior space of the connector, and axially into a hole in the opposing second housing end portion. The second elongated member extends axially into the connector in the opposite direction, by extending axially through a bore in the second housing end portion of the connector, axially through an interior space of the connector, and axially into a hole in the opposing first housing end. Thus installed, the first and second elongated members are radially offset from the longitudinal central axis of the connector, and so, in the relaxed configuration, are parallel to, but not coaxial with, the central element. In this relaxed configuration, the first elongated member is preferably entirely distanced from, and generally or exactly on the other side of the central element, relative to the second elongate member. For example, the first elongated member may be in the range of 95 degrees to 180 degrees from the entire second elongated member in the relaxed configuration, or more preferably in the range of 170-180 degrees or 180 degrees from the entire second elongated member in the relaxed configuration.

After insertion of the elongated elements into the connector, the housing portions are rotated relative to each other on the longitudinal central axis of the connector. As each of the elongated members enters the connector through one of the housing end portions and its respective end is in the other of the housing end portions, the elongated members may be said to extend axially past the ends of the central element and overlap axially with their ends pointing in opposite directions. With the elongated members thus installed, the rotation of the two housing end portions relative to each other will cause the portion of each elongated member that is in the interior space to move toward and wrap around the central element. Upon several 360 degrees rotations of the housing end portions relative to each other, each elongated member will have become wrapped/wound around the central element and, in certain embodiments, also around at least some of the other elongated member's coils on the central element, and the ends of the elongated members will have been pulled out of their respective holes in the housing end portions. In other words, because the elongated members ends are radially distanced from the longitudinal axis LA, the rotation of the elongated members causes the ends of the elongated members, including the portion previously installed in axial holes in the housing ends, to wrap around the central element. For example, as actuation/wrapping proceeds, each elongated member is pulled inward into the connector and the bundle/knot becomes tighter and tighter, to the point wherein the end of each of the elongated members slides inward out of the hole in its respective housing end portion to leave the hole and become part of the wrapped coils around the central element. Thus, wrapping typically also causes each elongated member end to wrap around and between the coils of the other elongated member, in effect, tightly tangled with each other and thus forming an entwined bundle or knot. Hence, the combination of the central element and wrapped and tangled wires because what may be called a “Western Knot”, “Western Splice” or simply “Splice” of twisted or tangled, and pulled, wires forming a durable and tight connection.

In certain embodiments, the elongated member ends are out of their respective holes and wrapped around/into the knot after 2-5, and more preferably 3-4, of the 360 degree rotations of one housing end relative to the other. After that, the resistance to rotation of one housing end relative to the other typically will be less. Further rotation of a given housing end relative to the other will typically cause little or no further wrapping, but instead, the elongated member entering the given housing end, the knot, and the other elongated member will rotate together, that is, as a unit or substantially as a unit. This helps prevent over-tightening and breakage as the user will sense the formation of the knot by sensing the lessening of resistance and will tend to stop rotation at that point. In many embodiments, the central element remains substantially or entirely straight throughout this actuation and wrapping process and remains the core of the knot. In other embodiments, the central element may deform somewhat due to the actuation and resulting wrapping forces. In other embodiments, deformation of the central element could possibly pull the first and second ends of the central element out of their respective holes/recesses in the first and second housing end portions, in which case the central element would remain the central core for the knot but could be described as being tangled with the entangled wires.

### BRIEF DESCRIPTION OF THE DRAWINGS

FIG. 1 is a longitudinal cross-sectional view of one embodiment of the invented connector, in the “relaxed” condition.

FIG. 2 is a longitudinal cross-sectional view of the connector of FIG. 1, after rotation of the housing portions relative to each other on the longitudinal central axis of the connector, wherein inserted wires are shown wrapped around the central element to the extent that the ends of the elongated members are no longer in the holes of their respective housing ends and a knot-type mechanical and electrical connection between the wires has been formed.

FIG. 3 is a longitudinal cross-sectional view of the connector of FIG. 1, in an embodiment wherein the housing portions are rotated relative to each other on the longitudinal central axis of the connector and the wires are wrapped around the central element and each other to form a knot-type mechanical and electrical connection wherein the wire coils are more overlapped and tangled together than in FIG. 2, and the central element is somewhat deformed but still form the “core” of the knot.

FIG. 4 is a side view of the connector of FIGS. 1-3, without the wires and in the relaxed condition.

FIG. 5 is an end view of the connector of FIG. 4.

FIG. 6 is a cross-sectional view of the connector of FIG. 4.

FIG. 7 is a side view of the connector, as in FIG. 4.

FIG. 8 is a radial cross-section of the connector of FIG. 7, viewed along the line 8-8 in FIG. 7.

FIG. 9 is an exploded perspective view of the connector of FIG. 7, illustrating embodiments of the preferred four components.

FIG. 10 is an inner end view of the housing end portion that is located on the right in FIG. 9, called the “housing right end portion”.

FIG. 11 is an inner end perspective view of the housing right end portion of FIGS. 9 and 10.

FIG. 12 is an outer end view of the housing right end portion of FIGS. 9-11.

FIG. 13 is a side view of the housing right end portion of FIGS. 9-12.

FIG. 14 is a side view of the sleeve that connects the two housing end portions, that is, the second to the left component in FIG. 9.

FIG. 15 is a perspective view of the sleeve of FIG. 14.

FIG. 16 is an end view of the sleeve of FIG. 14 viewed from the left of FIG. 14.

FIG. 17 is an end view of the sleeve of FIG. 14 viewed from the right of FIG. 14.

FIG. 18 is a perspective inner end view of the housing end portion that is located on the left in FIG. 9, called the “housing left end portion”.

FIG. 19 is an inner end view of the housing left end portion of FIG. 18, viewing FIG. 18 generally from the right.

FIG. 20 is a side view of the housing left end portion of FIGS. 18 and 19, with the housing left end portion rotated to place its inner end toward the left.

FIG. 21 is an outer end view of the housing left end portion of FIGS. 18-20.

FIG. 22 is a perspective view of another embodiment of the connector, wherein two elongated members are inserted into one end of the connector.

FIG. 23 is a side view of the connector of FIG. 22.

FIG. 24 is an inner end perspective view of a first housing portion of the connector of FIG. 22.

FIG. 25 is an inner end perspective view of a second housing portion of the connector of FIG. 22.

FIG. 26 is a longitudinal cross-sectional view of the connector of FIG. 22.

### DETAILED DESCRIPTION OF CERTAIN EMBODIMENTS

Referring to the Figures there are shown several, but not the only, embodiments of the invented connector, and of the connector in use to connect wires.

FIG. 1 is a longitudinal cross-sectional view of one embodiment of the invented connector, in the “relaxed” condition, wherein wires have been inserted into each end of the connector but no tightening-connection of the wires together has begun. It will be understood from this document and the drawings that the two wires (solid, stranded, and/or cables, for example, the insulated wires WI in FIGS. 1 through 3) each extend a distance from other equipment or structures to the connector, in many embodiments, for electrical connection inside the connector. FIG. 1 illustrates the connector 10 comprising two housing end portions 12, 14 held together by the cooperation of sleeve 16 with the housing end portions, and with stripped wires W1 and W2 inserted into the connector but not yet wrapped for connection to each other. The first wire W1 extends through bore 22 in the first housing end 12, through the open/hollow interior space 24 and into the hole 26 in the second housing end 14. Similarly, the second wire W2 extends into the opposite end of the connector, through bore 32 in the second housing end 14, through said interior space 24, and into hole 36 in the first housing end 12. In this “relaxed” configuration/condition, that is, prior to rotation of the housing ends and therefore prior to forming the knot, the wires to be connected (including the bare/insulation-stripped portions, and the insulated portions, if any) are entirely or substantially parallel to each other, extending axially through the connector but distanced from each other on opposite sides of the central element 40. In this embodiment, WI is used as a general term for the elongated members to be connected and points to the insulated portions of the elongated members, while W1 and W2 are used to point to the bare/insulation-stripped portions that will wrap around the central element 40.

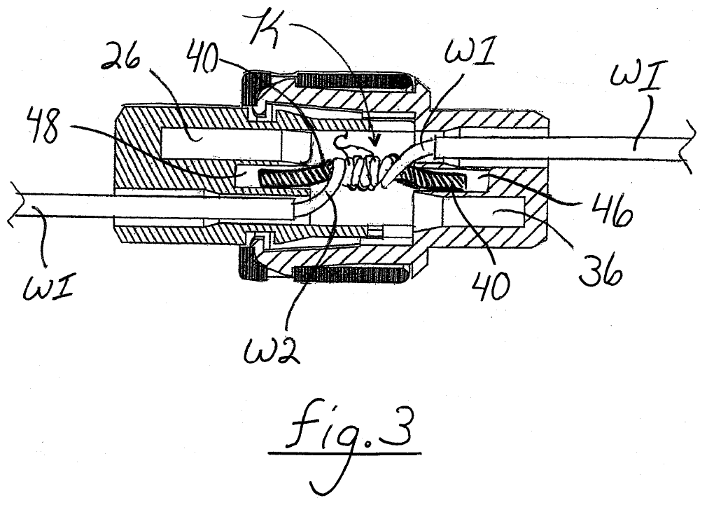

Central element 40 is preferably cylindrical and extends between and into each of the two housing ends 12, 14, by means of the ends 42, 44 of element 40 extending into the element holes 46, 48, respectively (46, 48 visible in FIG. 3), on the longitudinal central axis of the connector. In FIG. 1, central element 40 is therefore between the wires W1, W2, with W1, W2 radially offset/distanced from the element 40 preferably at least all along the length of the bare/uninsulated portion of the wires W1, W2. In the relaxed connector embodiment shown in FIG. 1, wires W1 and W2 are straight and parallel to each other. The locations/positions of W1 and W2 in FIG. 1 may be called a first position and a second position, and the first position and second positions are circumferentially distanced from each other around the circumference of the connector 10, for example, 180 degrees from each other as shown in FIG. 1. In other embodiments and/or orientations of the housing portions, the first and second positions may be in a range of positions, for example, a range of 95 degrees to 180 degrees from each other in the relaxed configuration, or more preferably in the range of 170-180 degrees from the entire second elongated member in the relaxed configuration.

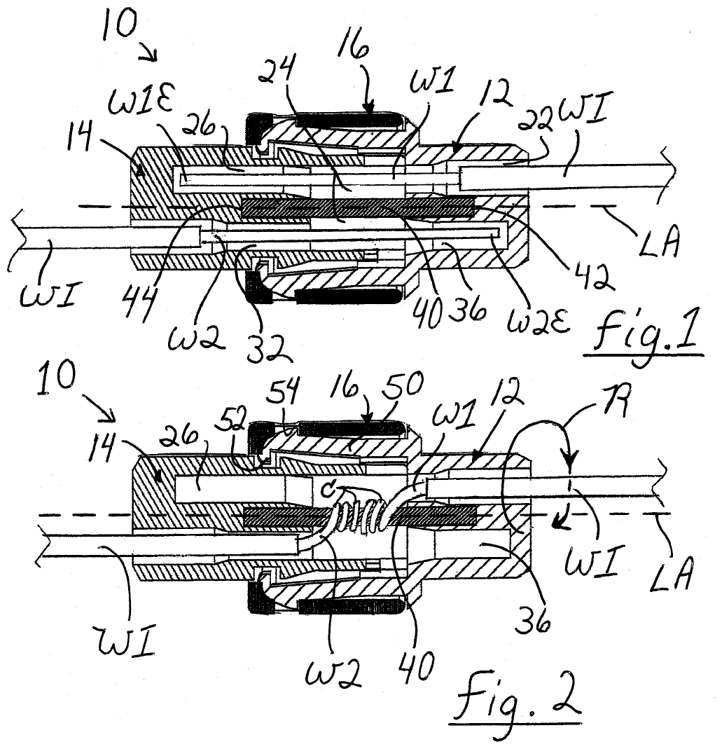

Referring to FIG. 2, actuation of the connector to make the wire connection by forming the knot has been done by rotating ends 12, 14 relative to each other, for example, by rotating with a user's right hand the right end 12 into the paper of FIG. 2 (schematically shown by the arrow R in FIGS. 2 and 9), while holding the left end 14 in the user's left hand. Due to the wires starting in positions radially offset from the element 40, the rotation serves to force/guide portions of the wires W1 and W2 that are in the interior space 24 to move against and around the element 40, which in turn pulls the wire ends W1E, W2E out of their respective holes 26, 36. FIG. 2 illustrates the wires W1, W2 each wrapped around the central element 40 several times, effectively forming a knot.

FIG. 3 illustrates an embodiment and method wherein the forces involved in wrapping the elongated members into a knot have caused a minor amount of central element deformation, in the form of curving/bending of the central element, but wherein the central element still forms the core of the knot. In certain alternative embodiments not shown in the Figures, the forces from rotating/twisting housing portions to wrap the elongated elements together in a knot may occur at angles and extents may deform the element 40 enough to pull the element ends 42, 44 out of their respective holes/recesses 46, 48.

With the elongated members extending through only their respective bores 26, 32 and being wrapped/tangled together at the knot, as in FIGS. 2 and 3, the resulting knot may be described as “floating inside” the connector. Further rotation of the ends 12, 14 relative to each other tends not to wrap the elongated members substantially further, but rather tends to rotate the wires and the knot as a single unit on the longitudinal axis of the connected wires and knot; this rotation tends to meet with less resistance than when the rotation is wrapping the wires around the central element, so the user becomes aware of what may be called the “fully connected” or “fully-knotted” wire condition. The user therefore can cease further rotation, and avoid extreme rotation that could, in some embodiments, break the wires W1, W2, the housing 12, 14, 16, or the central element 40.

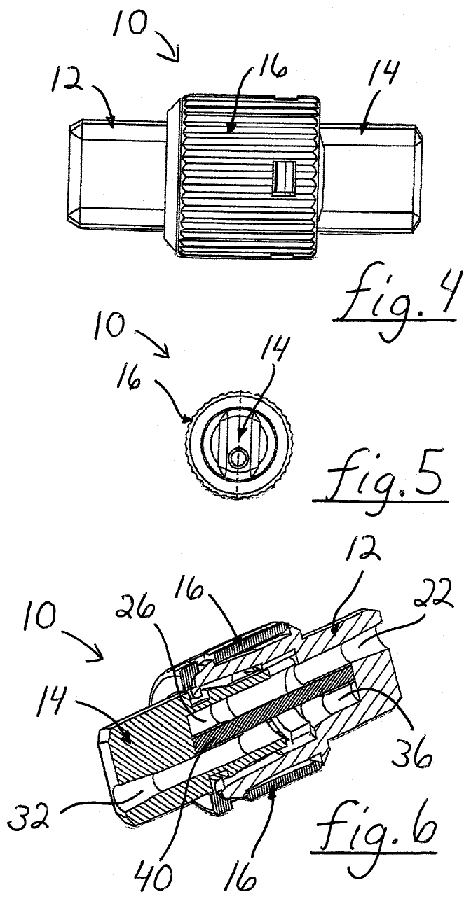

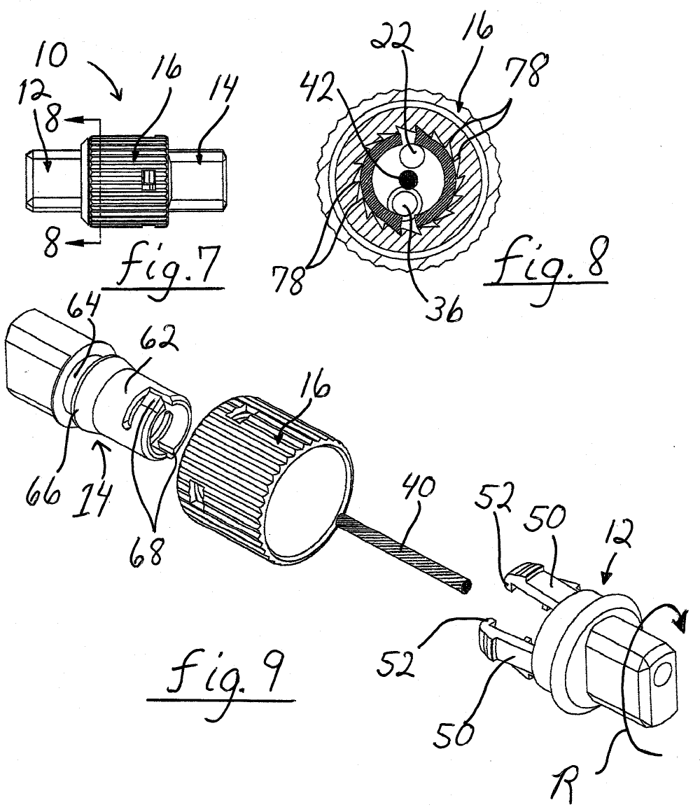

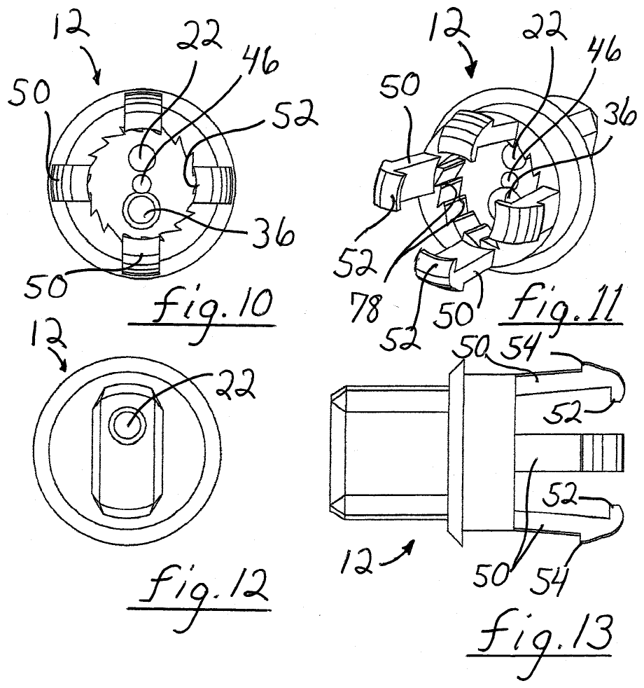

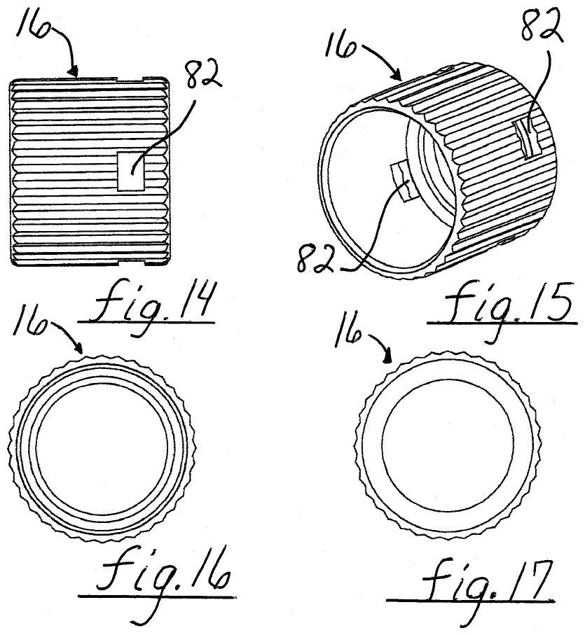

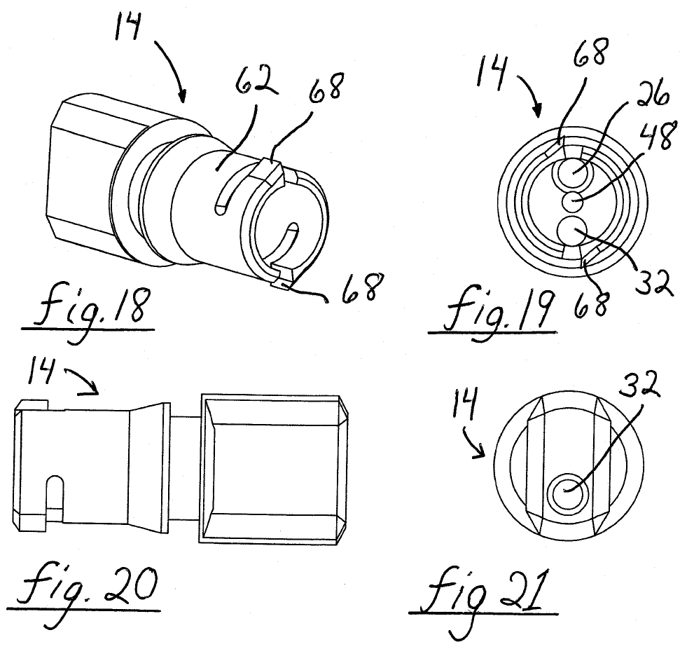

Therefore, FIGS. 2 and 3 are schematic illustrations of “the knot having been tied”, showing fairly orderly wrapping, where the wires are wrapped to form a wrapped/tangled knot holding the wires mechanically together, and in the case of an electrical use, electrically together. Certain embodiments, however, can accomplish this mechanical, and in the case of an electrical use, electric connection, with a more disorderly knot K, for example, wherein multiple wire strands of each of two cables being connected overlap and tangled together in a way that may make certain knot embodiments appear as a “tangled ball of wire”. In either an orderly or tangled knot, however, one or more tight coils of wire W1 will typically each be beside and/or extending over or under adjacent, tight coils of wire 2, whereby force in the direction of pulling wire W1 outward from the connector 10 will be resisted by the adjacent, tight coils of wire W2. Likewise, one or more coils of wire W2 will typically each be beside and/or extending over or under adjacent, tight coils of wire W1, whereby force in the direction of pulling wire W2 outward from the connector 10 will be resisted by the adjacent, tight coils of wire W1. FIGS. 4-9 show the connector embodiment of FIGS. 1-3 without the wires, using the reference numbers discussed above, FIGS. 10-13 further portray housing end 12, FIGS. 14-17 further portray the sleeve 16, and FIGS. 18-21 further portray housing end 14. End 12 has an outer handle portion and multiple resilient arms 50 that are adapted to extend over the inner tubular portion 62 of housing end 14, wherein the arms 50 are resiliently pushed toward the inner tubular portion 62 by the sleeve 16, so that the fingers 52 enter the circular recess 64 of the end 14 and are retained from axial movement by the flange 66 so that the ends 12, 14 do not slide or otherwise pull apart. As shown in FIGS. 8-11, the tubular portion 62 has at its inner end two circumferential resilient ratchet arms 68 that cooperate with the ratchet teeth 78 that form a circumferential ring of ratchet teeth inside end 12. The ratchet arms 68 and ratchet teeth 78 allow relative rotation of the ends 12, 14 in one relative direction, but prevent relative rotation in the reverse direction, thus, preventing uncoiling of the coils C of the knot K. Further, in FIGS. 4-21, one may see the bores, holes, and holes/recesses in housing ends 12, 14 that receive the wires and the central element, as described above regarding FIGS. 1-3.

One may see to best advantage, in FIGS. 14 and 15, the apertures 82 through the sleeve, into which the protrusions 54 on each arm 50 of end 12 will slide and be captured when the fingers 52 are received in the circular recess 64. Thus, the fingers thus captured in the circular recess and the end 12, and therefore prevented from moving any significant axial distance relative to end 14 but end 12 and the sleeve 16 may rotate together relative to end 14, with the fingers 52 sliding around end 14, circumferentially 360 degrees, in recess 64.

Certain embodiments of the connector may comprise, consist essentially of, or consist of four parts, that is, the male and female actuators (such as the portrayed housing end portions), a retaining ring (such as the portrayed sleeve), and a copper or other conductive and somewhat flexible rod serving as the central element. Water resistance may be added to the connector by using a water-resistant gel inside the connector or other sealant. Benefits of the preferred embodiments include that the connector is extremely easy to use, is very fast and reliable, and may be a watertight connection.

In certain embodiments, the device may be used as a quick connector of 18 gauge (or possibly down to 20 gauge and up to 16 gauge), low voltage (12 v-24 v) wires in the agricultural sprinkler industry or other irrigation systems, for example. Sprinklers are accompanied with electrical connections to transfer the charge to open/close the individual sprinkler solenoids.

The housing portions may be made of various materials, such as Lexan PC, polycarbonate clear, and/or various injection molded polymers such as PP, PPS, PPE, POM, PVC and ABS, for example. Preferably, materials that combine strength and the desired functions, along with the ability to be cast in clear components, are used. The center element or “rod” may be made of copper, but in certain embodiments could be other materials, for example, for electric embodiments, any conductive material, i.e. copper, aluminum, brass etc, depending on the type of connection being made and the application.

In use, one may obtain wires for the desired application and remove insulation, if present, for example, to markings on the body of the connector. Then, the wires are inserted into the connector, that is, one wire or group of wire strands of one cable into the hole on each end of the connector so that the wires/strands to be connected enter opposite ends of the connector and overlap axially inside the connector. Then, the user twists the housing ends relative to each other, for example for the ratchet system direction portrayed in the drawings, end portion 12 will be rotated clockwise in the view of FIG. 9 (see arrow R) approximately 3 times; after this approximate amount of rotation, the ends can continue to be turned even after the wire ends are securely attached to each other and the knot is formed. The device cannot be reversed due to the latch/lock system, for example, one such as the ratchet system portrayed in the Figures. It will be understood from the drawings that, if desired, an alternative ratchet system may be designed and manufactured for relative rotation in a direction that is the reverse of that shown in the Figures, followed by latching/locking in the resulting achieved tight condition. Further, it will be understood that alternatively latching/locking mechanisms may be provided instead of, or in addition to, a ratchet system; for example, a pin or clamp mechanism is envisioned as a mechanism for maintaining housing portions in the desired positions after actuation and formation of the knot connection.

A housing retainer system is provided for holding the two actuators/housing-ends from coming apart while twisting them to actuate the connector. One retainer system embodiment comprises resilient arms 50 on one of the housing ends, the circular recess/groove 64 on the other of the housing ends, and a retaining ring such as the cooperating sleeve 16 installed over/around the middle region of the housing ends. For example, the retaining ring holds arm tangs (such as fingers 52) down on the male housing portion in a recess/groove that allows the housing portions to rotate/twist relative to each other but not to fall apart from each other.

Certain embodiments may be described as a connector that connects first and second elongated members, the connector comprising: a connector housing having a longitudinal axis and a radial direction that is perpendicular to the longitudinal axis, the connector housing comprising a first housing portion and a second housing portion, each having a bore that is parallel to the longitudinal axis and offset from the longitudinal axis and each having a hole that is parallel to the longitudinal axis and offset from the longitudinal axis; a central element provided inside the connector housing at the longitudinal axis and extending between the first and second housing portions, wherein, when the connector is in a relaxed condition, the first elongated member extends through the bore in the first housing portion and into the hole in the second housing portion and is parallel to and radially distanced from the central element, and the second elongated member extends through the bore in the second housing portion and into the hole in the first housing portion and is radially distanced from the central element; and wherein the first housing portion is rotatable on the longitudinal axis relative to the second housing portion, and rotation of the first housing portion relative to the second housing portion moves the first and second elongated members against the central element and wraps the first and second elongated members in coils around the central element to a tightened condition in which a mechanical connection is formed between the elongated members. In certain embodiments, in the relaxed condition, the first elongated member extends through the bore in the first housing portion and into the hole in the second housing portion at a first position, and the second elongated member extends through the bore in the second housing portion and into the hole in the first housing portion at a second position, and the first position is in a range of 95-180 degrees from the second position. In certain embodiments, in the connector, the first position is 180 degrees from the second position. In certain embodiments, said rotation comprises rotating the first housing portion relative to the second housing portion 2-5 rotations of 360 degrees. In certain embodiments, said rotation comprises rotating the first housing portion in a first direction relative to the second housing portion and the connector further comprises a latching system that prevents rotation of the first housing portion relative to the second housing portion in a second direction opposite the first direction, and, in certain embodiments, the latching system is a ratchet system. In certain embodiments, the connector further comprises a housing retainer system adapted to hold the first housing portion and second housing portion from coming apart. In certain embodiments, the connector further comprises wherein the two elongated members being electrically conductive, so that the coils of the first and second elongated members around the central element in the tightened condition are electrically connected. In certain embodiments, the central element is also electrically conductive, so that all of the two elongated members and the central elements are electrically connected. In certain embodiments, the coils overlap each other. In certain embodiments, the first and second housing portions each have an element hole on the longitudinal axis, and the central element has a first end and a second opposing end that are received in the elements hole of the first and second housing portions. In certain embodiments, when said rotation wraps the first and second elongated members in coils around the central element to the tightened condition, the first elongated member has been pulled out of the hole in the second housing portion, and the second elongated member has been pulled out of the hole in the first housing portion. Certain embodiments of the invention comprise using the connector that is described by any, or multiple of, the sentences of this paragraph.

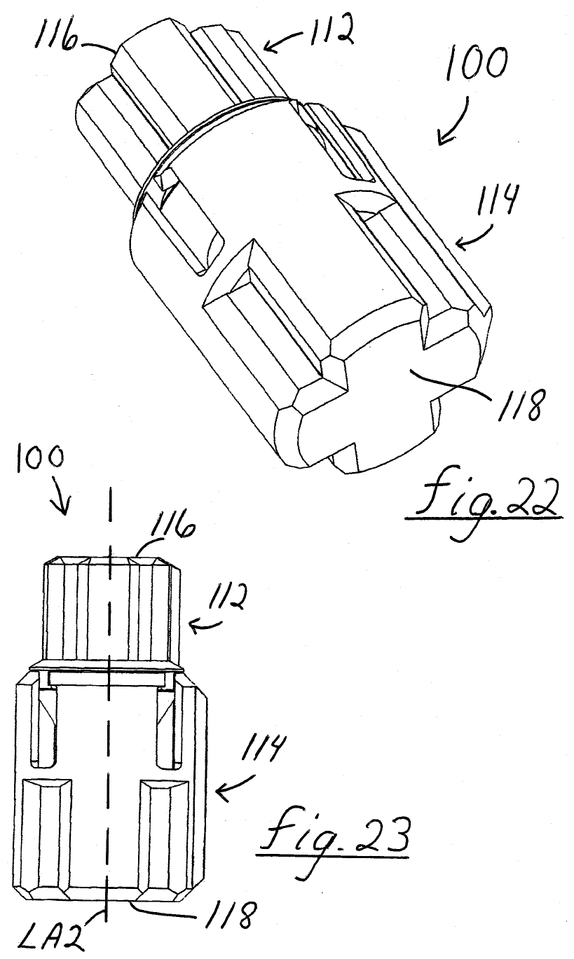

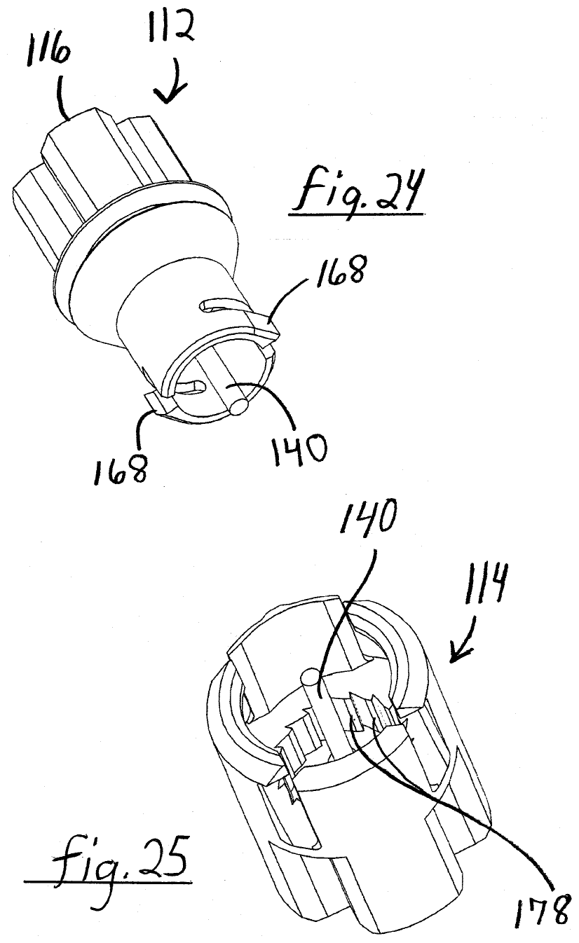

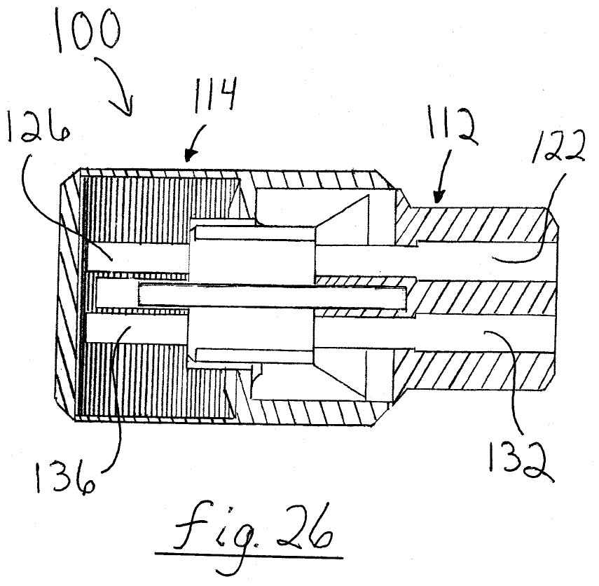

In the preferred embodiments of FIGS. 1-21, the electrically conductive wires or other elongated members are inserted into opposite ends of the connector, by one of the elongated members being inserted into the first housing portion toward the second housing portion, and the other elongated member being inserted into the second housing portion toward the first housing portion. However, in certain other embodiments such as the connector 100 shown in FIGS. 22-26, the connector 100 has first and second housing portions 112, 114, but both elongated members are inserted into one end 116 of the housing, that is, into the first housing portion 112 that has both bores 122, 132, and then the two elongated members extend from the first housing portion 112 into two holes 126, 136 both provided in the second housing portion 114, wherein the second housing portion is closed at its outer end 118. Then, similarly as in FIGS. 1-21, rotation of the first housing portion 112 relative to the second housing portion 114 will rotate the wires around a central element 140 that extends between the first and second housing portions. In FIGS. 24 and 25, the central element 140 is shown extending from both of the housing portions 112 and 114, but it will be understood that one central element is used that extends through the connector 100 along the longitudinal axis LA2 of the connector 100. The first and second housing portions 112, 114 will be held together while allowing relative rotation. A latching system, such as a ratchet arms 168 and ratchet teeth 178, is included for controlling the direction of relative rotation as described earlier in this document.

Although this invention has been described above with reference to particular means, materials, and embodiments, it is to be understood that the invention is not limited to these disclosed particulars and extends instead to all equivalents of apparatus and methods of operation and use that are within the broad scope of this disclosure including the drawings and the claims that follow.

1. A connector that connects first and second elongated members, the connector comprising:
a connector housing having a longitudinal axis and a radial direction that is perpendicular to the longitudinal axis, the connector housing comprising a first housing portion and a second housing portion, each having a bore that is parallel to the longitudinal axis and offset from the longitudinal axis and each having a hole that is parallel to the longitudinal axis and offset from the longitudinal axis;
a central element provided inside the connector housing at the longitudinal axis and extending between the first and second housing portions,
wherein, when the connector is in a relaxed condition, the first elongated member extends through the bore in the first housing portion and into the hole in the second housing portion and is parallel to and radially distanced from the central element, and the second elongated member extends through the bore in the second housing portion and into the hole in the first housing portion and is radially distanced from the central element;
wherein the first housing portion is rotatable on the longitudinal axis relative to the second housing portion, and rotation of the first housing portion relative to the second housing portion moves the first and second elongated members against the central element and wraps the first and second elongated members in coils around the central element to a tightened condition in which a mechanical connection is formed between the elongated members.

2. The connector of claim 1, wherein, in the relaxed condition, the first elongated member extends through the bore in the first housing portion and into the hole in the second housing portion at a first position, and the second elongated member extends through the bore in the second housing portion and into the hole in the first housing portion at a second position, and the first position is in a range of 95-180 degrees from the second position.

3. The connector of claim 2, wherein the first position is 180 degrees from the second position.

4. The connector of claim 1, wherein said rotation comprises rotating the first housing portion relative to the second housing portion 2-5 rotations of 360 degrees.

5. The connector of claim 4, wherein said rotation comprises rotating the first housing portion in a first direction relative to the second housing portion and the connector further comprises a latching system that prevents rotation of the first housing portion relative to the second housing portion in a second direction opposite the first direction.

6. The connector of claim 5, wherein the latching system is a ratchet system.

7. The connector of claim 5 further comprising a housing retainer system adapted to hold the first housing portion and second housing portion from coming apart.

8. The connector of claim 1, wherein the two elongated members are electrically conductive, so that the coils of the first and second elongated members around the central element in the tightened condition are electrically connected.

9. The connector of claim 8, wherein the central element is electrically conductive, so all of the two elongated members and the central elements are electrically connected.

10. The connector of claim 1, wherein the coils overlap each other.

11. The connector of claim 1, wherein the first and second housing portions each have an element hole on the longitudinal axis, the central element has a first end and a second opposing end that are received in the elements hole of the first and second housing portions.

12. The connector of claim 1, wherein, when said rotation wraps the first and second elongated members in coils around the central element to the tightened condition, the first elongated member has been pulled out of the hole in the second housing portion, and the second elongated member has been pulled out of the hole in the first housing portion.
